(19) United States
(12) Patent Application Publication
(10) Pub. No.: US 2015/0104285 A1
(43) Pub. Date: Apr. 16, 2015

(54) Device and method for securing nursery stock during transport

(71) Applicant: Warren Arthur Quinn, Kingsville, MD (US)

(72) Inventor: Warren Arthur Quinn, Kingsville, MD (US)

(21) Appl. No.: 14/055,840

(22) Filed: Oct. 16, 2013

(51) Int. Cl. B60P 7/135

(52) U.S. Cl. CPC B60P 7/135
USPC 414/800; 410/31

(57) ABSTRACT

One embodiment of a device and method for securing nursery stock during transport comprising a plurality of rigid vertical brackets (16) moveable along a rigid horizontal frame (22), each pair of said rigid vertical brackets connected by a flexible material (28) suspended between each pair of said brackets, and a means to support one or more horizontal rigid bars (34, 36) to secure plant tops. Said device assembled, placed on a truck or trailer bed, disassembled, and removed from the truck or trailer bed without tools or special skills.

Other embodiments are described and shown.

### CROSS-REFERENCE TO PPA

This application claims the benefit of Provisional Patent Application Ser. No. 61/795,413, filed Oct. 16, 2012, by the present inventor.

### BACKGROUND

A device for securing nursery trees and shrubs (hereinafter “nursery stock”) during transport is disclosed. Terminology used in this disclosure reflects terminology used in the nursery industry as set forth in the most recent edition of “American Standard for Nursery Stock,” ANSI Z60.1. [From 1995 through the date of this disclosure, the inventor has served as the managing editor of said publication.]

Nursery Stock Production, Harvest, and Preparation for Loading and Transport

As of the date of this disclosure, nursery stock is produced and harvested in several ways. The two most prevalent production and harvest methods are (a) nursery stock grown in the ground and harvested with the soil encasing the roots remaining intact, typically known as “field grown,” “balled and burlapped,” or “B&B” nursery stock, and (b) nursery stock grown in containers made of various materials, such as plastic, wood, or fabric, filled with soil media, with the containers either sitting on the ground or placed into slightly larger receptacle containers below the surface of the ground, typically known as “container grown” nursery stock.

For field grown nursery stock, as part of the digging and harvesting process, typical practice in the trade is to wrap or place the portion of the soil encasing the root system that is retained, typically known as the “root ball,” in a flexible material, such as burlap fabric. The flexible material is then secured to the outer surface of the root ball by rope or twine, typically referred to as “drum lacing,” or placed into a receptacle, often comprising a wire grid, typically referred to as a “wire basket,” in order to contain the root ball. The following examples of the use of fabric, rope, twine, or wire in prior art for preparing nursery stock for transport are cited:

| Patent | Date | Inventor | US Class |
|---|---|---|---|
| 4,062,148 | 12/1977 | Edmonds, Jr. | 47/76 |
| 4,250,664 | 2/1981 | Remke | 47/76 |
| 4,287,840 | 9/1981 | Weidner | 111/1 |
| 4,372,351 | 2/1983 | Myers | 140/112 |
| 4,403,447 | 9/1983 | Braun | 47/76 |
| 4,478,260 | 10/1984 | Eichler | 140/92.1 |
| 4,807,393 | 2/1989 | Bracken | 41/76 |
| 5,025,590 | 6/1991 | Smith | 47/76 |

In some cases, the commercial value of a single field grown plant is sufficient to warrant the expense of transporting it within the apparatus used to dig and remove it from the nursery field. Said apparatus is typically referred to as a “tree spade.” In such cases, the digging blades of the tree spade remain in place during transport as an encasement of the root ball, thereby serving the root ball containment function in lieu of drum lacing or wire basket configurations.

The following examples of a tree spade type apparatus and method for digging and transporting nursery stock in prior art are cited:

| Patent | Date | Inventor | US Class |
|---|---|---|---|
| 986,390 | 3/1911 | Hill | |
| 2,198,690 | 4/1940 | Wilmore | 214/3 |
| 4,114,766 | 8/1978 | Decker | 214/3 |
| 4,301,605 | 11/1981 | Newman | 37/2 |
| 4,403,427 | 9/1983 | Dahlquist | 37/2 |
| 5,081,941 | 1/1992 | Weeks | 37/2 |
| 5,600,904 | 2/1997 | Bowling | 37/302 |
| 6,070,344 | 6/2000 | Roberts | 37/302 |
| 7,600,480 | 10/2009 | Olson | 111/101 |

Container grown nursery stock is harvested from the nursery and transported with the container in which it was grown remaining intact.

The following examples of the use of containers for growing and transporting nursery stock in prior art are cited:

| Patent | Date | Inventor | US Class |
|---|---|---|---|
| 4,712,329 | 12/1987 | Anderson | 46/84 |
| 4,796,383 | 1/1989 | Inoue | 47/73 |
| 5,359,809 | 11/1994 | Johnson | 47/73 |
| 5,768,825 | 6/1998 | Reiger | 47/78 |
| 6,202,348 | 3/2001 | Reiger | 47/78 |
| 5,937,577 | 8/1999 | Butler | 47/73 |
| 6,637,155 | 10/2003 | Butler | 47/73 |

The above references to the two most prevalent production methods, harvest methods, and figures depicting typical configurations do not limit the application of this disclosure, and are provided solely to assist the reader's understanding of terms used in the nursery trade, common trade practices, and problems related to such practices that are addressed with this disclosure. With the sole exception of nursery stock harvested with the soil removed from around the roots, typically called “bare root” nursery stock, application of this disclosure includes all types of nursery stock, regardless of devices and methods used for production, harvest, and post-harvest preparation for loading and transport. Application of this disclosure also includes the transport of nursery stock for any purpose, including, among others, relocation among nursery fields or locations, delivery to another nursery for sale, planting, or re-potting, delivery to an installer for planting in the landscape, or delivery directly to the planting site.

Protection of Nursery Stock During Handling

When nursery stock is damaged during transport, the nursery and landscape industry incurs direct costs, such as reduced marketability and higher replacement costs, and indirect costs, such as reduced customer satisfaction from plant death and non-fatal, aesthetic damage. Consumers of landscape services, including residential property owners, commercial property owners, institutions, and government, incur property damage and replacement costs when the long-term effects of damages to nursery stock caused during transport become evident in the landscape. The economic, aesthetic, and emotional values of plants in the landscape are harmed when plants decline and die.

At the point at which nursery stock is prepared for transport, both of the most prevalent production and harvest methods described above converge at a fundamental level. Specifically, nursery stock is transported from the site of harvest with the roots encased in the soil in which it was grown, and with the soil then encased within some type of structure or apparatus intended to retain the integrity of the connection between the soil and the roots of the nursery stock. Without the soil containment structure, the soil would break loose from the roots during lifting, loading, transporting, unloading, or delivering the nursery stock to the intended site. If the soil breaks loose from the roots during any of these processes, the rate of survival of the nursery stock is reduced, either while it remains above the ground or after being re-planted in a nursery or in the landscape. Devices and methods of transport should therefore minimize the effects of forces that would displace the soil or damage the root/soil system within the soil containment structure.

Hereinafter, all devices and methods intended to contain the soil encasing the root system will be referred to as “soil containment structure” unless significant differences in industry practices related to this disclosure warrant a distinction between “field grown” and “container grown” nursery stock. The relationship between the roots and the soil encasing the roots, independent of the soil containment structure, will be referred to as the “root/soil system.”

A second key factor in the survivability of nursery stock is to maintain the relationship between the soil containment structure and the portion of the nursery stock that extends upward from the soil. The primary components of the “plant top” are trunks (or stems), branches, and leaves. Practices in the trade are intended to minimize the amount of independent leverage applied to the soil containment structure or the plant top. Whenever such leverage is applied to the soil containment structure or the plant top against the other, through human action or independent sources (e.g., wind), the integrity of the root/soil system is compromised, thereby reducing the survival rate of the nursery stock thereafter. To the extent possible, the root/soil system and the plant top should be handled and secured as a single unit during digging, lifting, loading, transporting, unloading, or delivering the nursery stock to the intended site. Devices and methods of transport should therefore minimize the effects of forces that would cause the soil containment structure and the plant top to move independently of each other.

The following examples of prior art for devices and methods intended to limit the independent movement of the plant top and the root/soil system, while nursery stock is statically located in the ground in the nursery, in a soil containment structure, or newly planted in the landscape, are cited:

| Patent | Date | Inventor | US Class |
|---|---|---|---|
| 6,302,368 | 10/2001 | Tsappi | 248/523 |
| 6,702,239 | 3/2004 | Boucher | 248/156 |
| 6,772,558 | 8/2004 | Mancini | 47/42 |
| 6,938,370 | 9/2005 | Johns | 47/42 |
| 8,132,361 | 3/2012 | Poyas | 47/42 |
| 8,316,579 | 11/2012 | Brown | 47/42 |
| 8,336,252 | 12/2012 | Ammons | 47/42 |

Industry practices related to the processes described in this disclosure also intend to retain the aesthetic appeal and therewith the commercial value of nursery stock. This is accomplished by minimizing damage to the plant top structure, including branches and the tissues surrounding the vascular cambium of the trunks, stems, and branches, commonly referred to as “bark.” Such damage may be severe enough to threaten the survival of the nursery stock if food required for survival cannot be transported through the cambium. Nursery stock with damaged bark or broken branches may be rejected by buyers even if the damage does not threaten the health of the nursery stock and can be corrected over time through pruning or other techniques. Common practice is to tie branches together and place a protective barrier around tree trunks in order to prevent such damage in preparation for and during transport. Devices and methods of transport should therefore minimize the effects of forces that would cause damage to the plant top structure.

Necessity and Commercial Benefit of Loading and Transporting Nursery Stock at an Angle

In cases where the combined total height of the soil containment structure and the plant top of nursery stock loaded on a truck or trailer bed in a fully vertical (upright) manner would interfere with overhead wires, structures, or natural impediments on the route of transport (e.g., branches of trees growing along the route of transport), or would exceed the height dimension of an enclosed cargo area, the nursery stock must be loaded such that the plant tops would pass safely below overhead impediments or fit within the cargo enclosure. However, loading nursery stock in a fully horizontal position reduces the available space remaining in the truck or trailer bed for additional units to the extent that the plant tops prevent additional units from being placed in the space occupied by the plant tops resting on or immediately above the truck or trailer bed. This limits the commercial value of nursery stock that can be transported on a truck or trailer bed in a single transport load. Current practice in the industry intended to hold nursery stock at an angle with the truck or trailer bed is to place loose landscape materials, such as mulch, soil, or gravel, or bagged landscape materials, such as mulch, soil, or gravel, or pieces of wood, rock, or other rigid material in the space between the soil containment structure and the truck or trailer bed during the loading process. When materials for this purpose are not attached securely to the soil containment structure or to the truck or trailer bed, they tend to release from their position during transport, thereby vitiating this function. Devices and methods for transport should therefore provide for nursery stock to be loaded and transported at an angle that allows the plant tops to pass safely under overhead impediments on the route of transport, or to fit within the cargo enclosure, and that provides space beneath the plant tops for additional units of nursery stock.

The following examples of prior art related to transporting nursery stock at an angle are cited:

| Patent | Date | Inventor | US Class |
|---|---|---|---|
| 2,264,571 | 12/1941 | Jeffrey | 214/3 |
| 2,545,241 | 3/1951 | Pearson | 214/3 |
| 2,614,705 | 10/1952 | Coplen | 214/3 |
| 4,709,955 | 12/1987 | Peters | 296/3 |
| 4,796,941 | 1/1989 | Reilly | 296/3 |

Challenges of Transporting Nursery Stock at an Angle

Nursery stock that is loaded and transported at an angle is subject to damage during transport.

First, if the plant top does not rest at the same angle as the sidewall of the soil containment structure, only a portion of the sidewall rests on the truck or trailer bed. In such cases, the sidewall of the soil containment structure will not distribute the weight of the soil evenly on the truck or trailer bed, thereby creating opposing forces between the root/soil system and the plant top. As the truck or trailer passes over bumps and pits in the road surface, leverage is applied independently against the root/soil system and the plant top, thereby damaging the nursery stock. Current practice in the industry intended to evenly distribute the weight of the soil containment structure on the truck or trailer bed is to place loose landscape materials, such as mulch, soil, or gravel, or bagged landscape materials, such as mulch, soil, or gravel, or pieces of wood, rock, or other rigid material in the space between the soil containment structure and the truck or trailer bed during the loading process. When materials are not attached securely to the soil containment structure or to the truck or trailer bed, they tend to release from their position during transport, thereby vitiating this function. Devices and methods of transport should therefore align and maintain the angle of the soil containment structure and the plant top during transport.

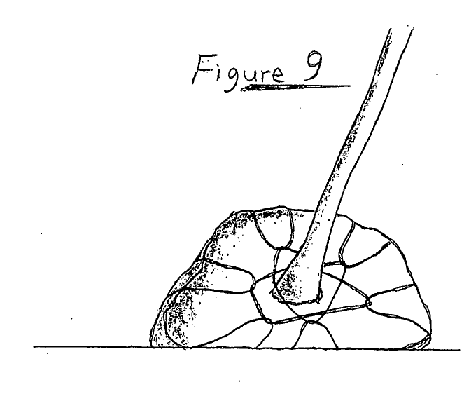

Secondly, if the soil containment structure is not sufficiently rigid, the soil will break apart and become disconnected from the roots. The curved sidewall of a soil containment structure with a cylindrical or conical configuration will have minimal contact with a flat truck or trailer bed. During transport, as the truck or trailer passes over bumps and pits in the road surface, significant downward pressure is placed on the soil containment structure until additional area of the sidewall rests on the truck or trailer bed, thereby damaging the nursery stock. Current practice in the industry intended to retain the shape of the soil containment structure is to place loose landscape materials, such as mulch, soil, or gravel, or bagged landscape materials, such as mulch, soil, or gravel, or pieces of wood, rock, or other rigid material in the space between the soil containment structure and the truck or trailer bed during the loading process. When materials are not attached securely to the soil containment structure or to the truck or trailer bed, they tend to release from their position during transport, thereby vitiating this function. Devices and methods for transport should therefore support the soil containment structure in a manner that retains its shape (FIG. 9).

Thirdly, if the soil containment structure and the plant top are not sufficiently secured during transport, or if the soil containment structure is secured independently of the securement of the plant top, the lateral (side-to-side) movement of the truck or trailer as turns are made along the route of transport will cause the nursery stock to roll. The torque of the rolling motion of the root/soil system within the soil containment structure and independent of the secured plant top loosens the soil from the roots and damages the nursery stock. Also, if the torque from the rolling motion of the soil containment structure exceeds the securement of the plant top, the plant top will twist within its securement, causing damage to the plant top, such as torn bark or broken branches.

Current practice in the industry intended to prevent nursery stock from rolling laterally during transport is to use rope or straps to tie the soil containment structure(s) together and to the truck or trailer bed and place loose landscape materials, such as mulch, soil, or gravel, or bagged landscape materials, such as mulch, soil, or gravel, or pieces of wood, rock, or other rigid material in the space between the soil containment structure and the truck or trailer bed during the loading process. This method is called “chocking,” and materials and devices for this purpose are called “chocks.” When chocks are not attached securely to the soil containment structure or to the truck or trailer bed, they tend to release from their position during transport, thereby vitiating their chocking function. Devices and methods for transport should therefore provide and maintain the chocking function and prevent the soil containment structure from rolling laterally.

The following examples of prior art related to securement of general cargo are cited:

| Patent | Date | Inventor | US Class |
|---|---|---|---|
| 2,608,420 | 8/1952 | Eck | |
| 4,121,849 | 10/1978 | Christopher | 280/179 |
| 4,650,383 | 3/1987 | Hoff | 410/149 |
| 4,720,222 | 1/1988 | Nagy | 410/151 |
| 4,722,646 | 2/1988 | McIntyre | 410/138 |
| 6,340,106 | 1/2002 | Dutton | 224/405 |
| D467,862 | 12/2002 | Jenkins | D12/414 |
| 7,740,430 | 6/2010 | Mchugh | 410/89 |
| D639,231 | 6/2011 | Walsh | D12/414 |
| 8,303,221 | 11/2012 | Lenz | 410/140 |

Fourthly, devices and methods for securement of nursery stock must be cost-efficient so that they are operationally feasible and commercially accepted in the trade. Although the common use of various materials readily at hand described above may be perceived in the industry as cost-effective, the actual cost of the inadequate securement that results may not be included in the decision to use more effective devices or methods. Conversely, devices and methods that are complex require specialized skills and significant time to assemble and disassemble. Devices that are permanently integrated with the truck or trailer, or require more than one person, significant time, or specialized tools or skills to mount and remove, increase the costs to the trade and make it difficult to use the truck or trailer for purposes other than transporting nursery stock. Devices and methods for transport should therefore provide for assembly and loading of the securement device onto the truck or trailer bed, securement of nursery stock with the device, and disassembly and unloading of the device from the truck or trailer bed to be done by one person quickly, without specialized skills, and without specialized tools in order to minimize labor costs and allow the truck or trailer bed to be utilized for other purposes.

The following examples of prior art for securement of cylindrical articles similar in some respects to typical soil containment structures during transport are cited:

| Patent | Date | Inventor | US Class |
|---|---|---|---|
| 6,536,612 | 3/2003 | Flores | 211/85.22 |
| 7,070,372 | 7/2006 | Denike | 410/46 |
| 7,077,269 | 7/2006 | Kissell | 206/446 |

### PRIOR ART DOES NOT SOLVE CHALLENGES OF TRANSPORTING NURSERY STOCK

Prior art using fabric, rope, twine or wire baskets to contain field grown root balls does not sufficiently protect the root ball to prevent soil from breaking loose from the roots during transport. Prior art related to the use of “tree spade” or other types of mechanical digging devices that can also be used to lift and transport field grown nursery stock is limited to the transport of single units of significant commercial value and do not provide a commercially viable solution for transporting multiple units that are more prevalent in the retail nursery and landscape nursery trade. Prior art related to containers for encasing the soil/root system of container grown nursery stock does not include devices or methods of securement during transport or sidewalls angled to facilitate the alignment of root containment structures and plant tops when nursery stock is loaded at an angle. Prior art related to limiting the independent movement of the plant top while statically located in the nursery or after planting in the landscape does not provide a similar or adequate function during transport of nursery stock. Prior art related to transporting nursery stock at an angle is limited to single-purpose trucks or trailers for the transport of nursery stock with exceptionally high commercial value, and is not applicable to nursery stock that is typically transacted in the retail nursery and landscape trade. Prior art related to the securement of general cargo does not provide the required securement for nursery stock. Prior art for securement of cylindrical articles similar in some respects to typical soil containment structures during transport is limited in application to cylindrical articles with rigid sidewalls that will retain their shape during transport, does not address the need to conform to and maintain the shape of the container during transport, and does not address the existence of the plant top structure extending upward from the cylindrical article and subject to forces that would damage the cylinder or the structure of the materials contained therein.

### SUMMARY

In accordance with one embodiment, a device and method for securing nursery stock during transport comprises (a) a soil containment structure securement unit including two or more rigid vertical brackets adjustable by sliding along, and removable from, a rigid horizontal frame and connected one bracket to another by a flexible material, functioning as a sling, connected by a handle at each end of the sling to a cleat on the upper edge of each opposing bracket, and (b) a plant top securement unit including two vertical rigid brackets foldable by hinges attached to the two opposing ends of a frame and supporting two horizontal rigid and padded bars, both units able to be assembled, installed onto a truck or trailer bed, disassembled, and removed from the truck or trailer bed by one person quickly and without specialized tools or skills.

### Advantages

Accordingly several advantages of one or more aspects are as follows:
To minimize the effects of forces that would displace soil during transport of nursery stock;
To minimize the effects of forces that would cause the root/soil system and the plant top to move independently of each other during transport of nursery stock;
To minimize the effects of forces that would cause damage to the plant top structure during transport of nursery stock;
To provide for nursery stock to be loaded and transported at an angle that allows the plant tops to pass safely under overhead impediments on the route of transport, or to fit within the cargo enclosure;
To provide for nursery stock to be loaded and transported at an angle that provides space beneath the plant tops for additional units of nursery stock;
To align and maintain the angle of the soil containment structure and the plant top during transport of nursery stock;
To support the soil containment structure in a manner that conforms to and retains its shape during transport of nursery stock;
To provide and maintain the chocking function during transport of nursery stock to prevent the soil containment structure from rolling laterally; and
To provide for assembly and loading of the securement device onto the truck or trailer bed, effective securement of nursery stock with the device, and disassembly and unloading of the device from the truck or trailer bed to be done by one person quickly, without specialized skills, and without specialized tools in order to minimize labor costs and allow the truck or trailer bed to be utilized for other purposes.

Other advantages of one or more aspects will be apparent from a consideration of the drawings and ensuing description.

### DRAWINGS

### Figures

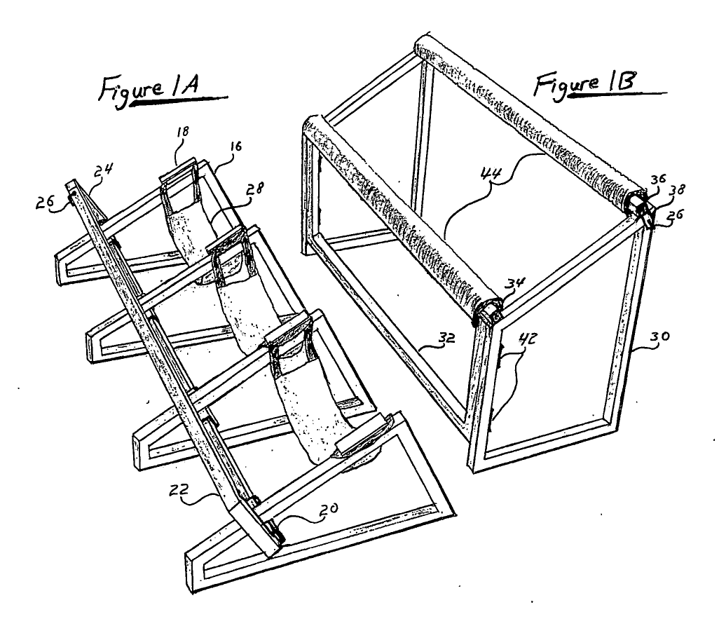

FIGS. 1A and 1B show the device disclosed according to the first embodiment, including the soil containment structure securement unit (FIG. 1A) and the plant top securement unit (FIG. 1B)

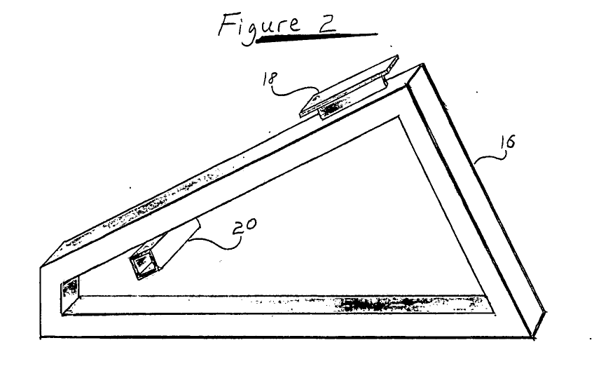

FIG. 2 shows the vertical bracket of the soil containment structure securement unit in accordance with the first embodiment

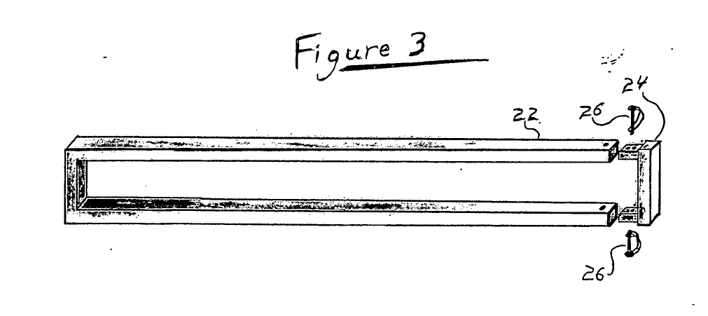

FIG. 3 shows the horizontal frame and removable end cap bar of the soil containment securement unit in accordance with the first embodiment

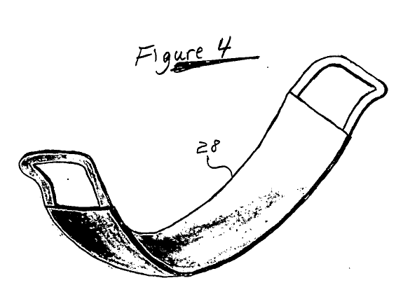

FIG. 4 shows the flexible material “sling” of the soil containment securement unit in accordance with the first embodiment

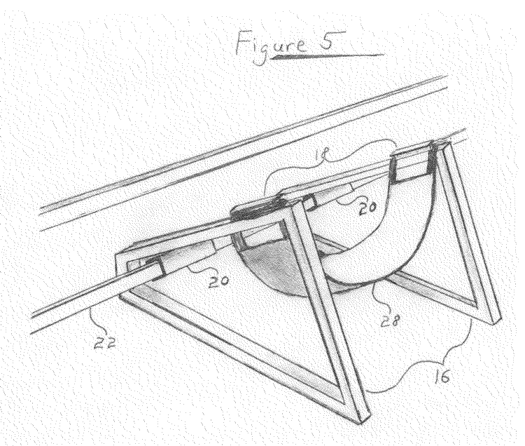

FIG. 5 shows the detail of the mechanism that allows the vertical bracket of the soil containment securement unit to slide along the horizontal frame as the weight of the soil containment structure is lowered to a resting position on the sling attached to the cleat on the top edge of each bracket.

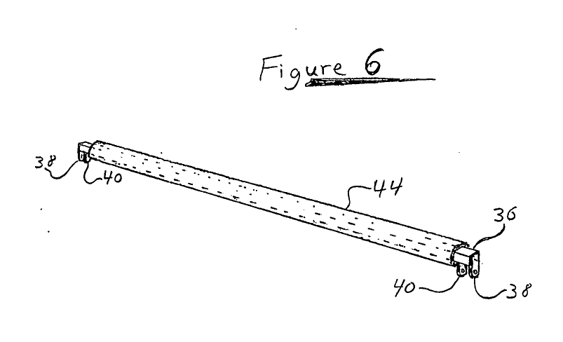

FIG. 6 shows the removable rigid horizontal padded bar of the plant top securement unit in accordance with the first embodiment

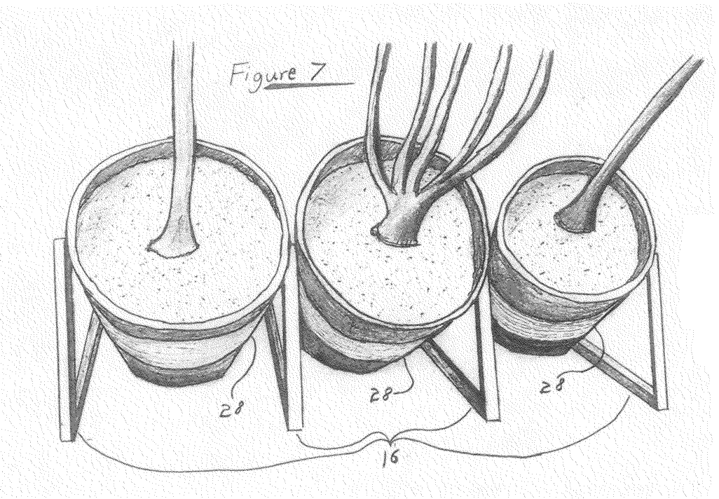

FIG. 7 shows a typical installation of nursery stock resting on the slings and between the sliding vertical brackets of the soil containment securement unit in accordance with the first embodiment

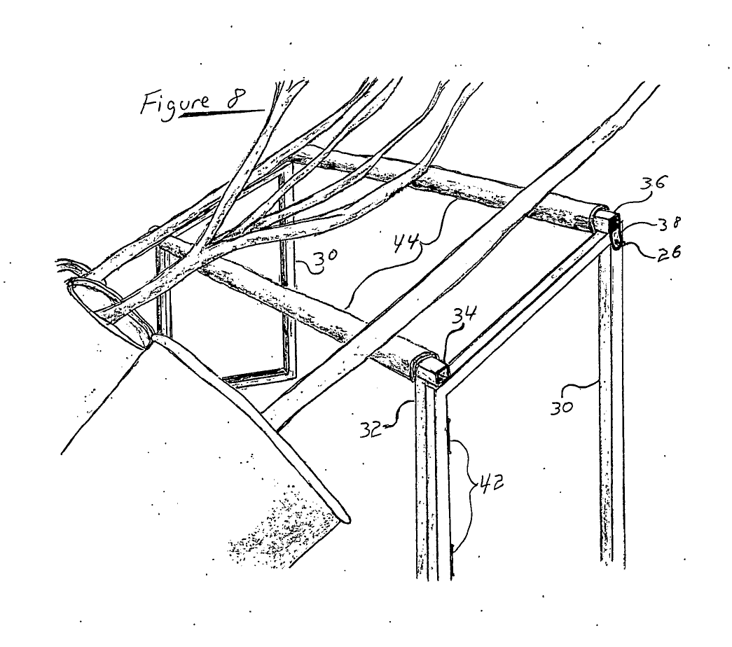

FIG. 8 shows a typical installation of nursery stock resting on the padded horizontal support bars of the plant top securement unit in accordance with the first embodiment

FIG. 9 shows a conical soil containment structure in a wire basket configuration typical for field grown nursery stock which has been damaged as a result of insufficient support required to retain the shape of the soil/root system during transport

### DRAWINGS

### Reference Numerals

16 Bracket A
18 Cleat
20 Channel
22 Frame A
24 End cap bar
26 Clip
28 Sling
30 Bracket B
32 Frame B
34 Support bar
36 Removable support bar
38 Exterior tab
40 Interior tab
42 Hinge
44 Padding

### DETAILED DESCRIPTION

### First Embodiment—FIGS. 1 Through 8

One embodiment of the device is illustrated in FIG. 1A, showing the soil containment structure securement unit of the device (FIG. 1A) and the plant top securement unit of the device (FIG. 1B).

These are what I presently contemplate for this embodiment, but other values, angles, dimensions, and materials may be used.

The primary components of the soil containment structure securement unit (FIG. 1A) are four brackets A 16, three slings 28, and a frame A 22.

Each bracket A 16 (FIG. 2) is an irregular quadrilateral of welded 11-gauge, 1¼-inch steel square tube, with interior angles of 90°, 30°, 90°, and 60°, such that when bracket A 16 is placed vertically the top member is positioned at a 30° angle with the bottom member of bracket A 16. The length of the top member is 23 inches, the length of the bottom member is 27½ inches, the length of one end member is 3¾ inches, and the length of the other end member is 15¾ inches.

A channel 20 is made of 11-gauge, 1%-inch steel square tube and welded beneath the bottom wall of the top member of bracket 16 perpendicularly to the top member at a position between 6 inches and 7.5 inches from the lowest end of the top member.

A cleat 18 is made of two pieces of 1-inch wide, ¼-inch steel plate, one 4 inches long and one 5 inches long, each piece welded longitudinally and perpendicularly to each other in the manner of a “T,” with the 4-inch piece serving as the “leg” of the “T” and the 5-inch piece serving as the “top” of the “T.” Cleat 18 is welded longitudinally along the center of the top edge of the top member of bracket A 16 at a position between 2 inches and 6 inches from the upper end of the top member of bracket A 16.

Each sling 28 (FIG. 4) is constructed as a basket-style continuous eye wide type, similar in style and manufacture to commercially available slings. The basket portion of sling 28 described in this embodiment is 6 inches wide and 20 inches long, and is made of 1000 denier nylon fabric. The continuous handle is 64 inches long, made of 1″ wide 25 mm nylon webbing, and sewn continuously along the basket such that 12 inches of webbing is exposed at each end of the fabric basket to serve as the two handles.

A frame A 22 (FIG. 3) is made of 11-gauge, 1¼-inch steel square tube configured as an elongated rectangle with one of the short sides missing from the rectangle. The long sides are 60 inches measuring along the outside of frame A 22, and the single short side is 8 inches measuring along the outside of frame A 22. A ⅜-inch hole is drilled ½ inch from the end of the long members to receive a ¼-inch locking-style clip 26 to attach an end cap bar 24 to frame A 22. The ends of the long members remain open to receive the plug inserts of end cap bar 24. The vertical member of end cap bar 24 is made of 11-gauge, 1¼-inch steel square tube and measures 8 inches. Two plug inserts made of 1-inch solid steel bar measuring 2 inches are welded perpendicularly to each end of the vertical member of end cap bar 24 in positions to align with the open ends of the long members of frame A 22. A ⅜-inch hole is drilled in each plug insert ½ inch from the weld to align with the hole in the long members of frame A 22 when inserted therein and receive a ¼-inch locking-style clip 26 to attach end cap bar 24 to frame A 22.

Clip 26 is commercially available.

The primary components of the plant top securement unit (FIG. 1B) are two brackets B 30, a frame B 32, a lower padded support bar 34, and an upper removable padded support bar 36 (FIG. 6).

Each bracket B 30 is a trapezoid of welded 11-gauge, ¼-inch steel square tube, with interior angles of 90°, 30°, 90°, and 60°, such that when bracket B 30 is placed vertically the top member is positioned at a 30° angle with the bottom member of bracket B 30. The two vertical members are parallel with each other. The length of the top member is 20½ inches and the length of the bottom member is 18 inches. One vertical member measures 28¼ inches and one vertical member measures 18 inches.

A frame B 32 is made of 11-gauge, 1¼-inch steel square tube, constructed generally as a rectangle placed vertically with the long sides on the bottom and top. The bottom member of frame B 32 measures 45½ inches and the two shorter vertical members measure 14 inches. The upper ends of the shorter vertical members are cut at a 60° angle. Support bar 34 is the top member of frame B 32, measures 48 inches, and is welded to the upper ends of the shorter vertical members of frame B 32 such that the remaining 1¼ inch at each end of support bar 34 rests on the top members of brackets B 30. The shorter vertical members of frame B 32 align with the shorter vertical members of brackets B 30. The bottom member of frame B 32 does not rest on the ground with the bottom members of brackets B 30. With frame B 32 in the correct position, frame B 32 and brackets B 30 are attached to each other with two hinges 42 on each of the shorter vertical members of frame B 32 and the shorter vertical members of brackets B 30.

A removable support bar 36 (FIG. 6) is made of 11-gauge, 1¼-inch steel square tube and measures 48¼ inches. Interior tab 40 is made of 1-inch wide ⅛-inch steel plate and measures 1½ inches. Interior tab 40 is welded along its short (one-inch) edge perpendicularly to each end of removable support bar 36 at the position between ¼ inches and 1⅜ inches from the end of removable support bar 36. Exterior tab 38 is made of 1-inch wide ⅛-inch steel plate and measures 2¾ inches. Exterior tab 38 is welded with one end aligned with and enclosing each end of removable support bar, such that the remaining 1½-inch portion aligns with interior tab 40. Both tabs 38 and 40 extend perpendicularly from each end of removable support bar 36.

Removable support bar 36, with interior tab 40 and exterior tab 38 attached, is placed on the top members of two brackets B 30 such that brackets B 30 are placed between a set of tabs. Removable support bar 36 is positioned such that it rests on the top members of brackets B 30 about 2 inches from the upper end of the top members of brackets B 30. In this position, the ends of the tabs align with the upper ends of the longer vertical upright members of brackets B 30. On each end, a ⅜-inch hole is drilled through the portion of exterior tab 38 that extends from removable support bar 36, then through the longer vertical upright member of bracket B 30, then through interior tab 40, in order to insert a ¼-inch locking-style clip 26 to secure removable support bar 36.

Padding 44 is commercially-available elastomeric pipe insulation, 1½-inch outside diameter pipe measurement, ½-inch wall thickness, cut to 45 inches. One piece of padding 44 is placed around removable support bar 36 and one piece of padding 44 is place around support bar 34. Commercially-available PVC tape (not shown in this embodiment) may be wrapped around the padding 44 to protect it from damage during use.

### OPERATION AND METHOD

### First Embodiment

This first embodiment contemplates securement of container grown nursery stock in containers up to ANSI Z60.1 #20 container class or field grown nursery stock with ANSI Z60.1 root balls up to 21″ diameter.

Soil containment structure securement unit (FIG. 1A) is assembled by inserting the open end of the lower member of frame A 22 through channel 20 of each bracket A 16, inserting end cap bar 24 into the ends of frame A 22 so that the holes in the plug inserts of end cap bar 24 align with the holes in the ends of the top and bottom members of frame A 22 (FIG. 3), and inserting clip 26 in the top set of holes and inserting clip 26 in the bottom set of holes. Each bracket A 16 is moved laterally along frame A 22 until there is an equal space between them, with the first and fourth bracket A 16 located at each end of the lower member of frame A 22. Each sling 28 is installed by looping the handles around cleat 18 of two opposing brackets A 16 (FIG. 5).

The soil containment structure securement unit (FIG. 1A) is loaded onto the truck or trailer bed in a lateral (side-to-side) position with frame A 22 as near as possible to the front (forward direction during transport) of the truck or trailer bed.

(FIG. 7) The soil containment structure of the first unit of nursery stock is lowered into the left-most or right-most sling 28 with the plant top facing toward the rear of the truck or trailer bed and with the overall shape of the plant top at a 30° angle with the truck or trailer bed. The soil containment structure, brackets A 16, and sling 28 are manipulated such that sling 28 bears the overall weight of the soil containment structure, the lowest point of the bottom ring of the soil containment structure rests on the truck or trailer bed, the bottom of the soil containment structure rests on frame A 22, and sling 28 fits tightly around the circumference of the soil containment structure. In this position, unless the plant top is unusually dense and heavy, the soil containment structure is secured such that the nursery stock remains in this position without any additional human or mechanical support beneath the plant top. If the sling needs to be shortened to achieve the correct position described above, the nursery stock is removed, one or both sling 28 handles are twisted and re-installed on cleats 18, and the nursery stock is loaded again in the manner described in this paragraph until the correct position is achieved.

If more than one unit of nursery stock is to be transported, it is loaded in the adjacent sling 28 in the same manner.

If a third unit of nursery stock is to be transported, it is loaded in the third sling 28 in the same manner.

The plant top securement unit (FIG. 1B) is assembled by unfolding hinged brackets B 30 to a position 90° from frame B 32, placing removable support bar 36 on brackets B 30, aligning the holes in tabs 38 and 40 with the holes in the upper ends of the longer vertical upright member of brackets B 30, and attaching removable support bar 36 by inserting clip 26 in each end.

The plant top securement unit (FIG. 1B) is loaded laterally (side-to-side) on the truck or trailer bed with support bar 34 toward the front of the truck or trailer bed by sliding it underneath the plant tops of the nursery stock (FIG. 8), taking care to lift branches to avoid damage to the plant top, until the plant tops rest firmly on padding 44 of support bar 34, of removable support bar 36, or both.

(Not shown) The soil container structure securement unit (FIG. 1A) is connected to the plant top securement unit (FIG. 1B) by taut application of commercially available flexible straps, commonly referred to as “bungee cords,” wrapped or hooked to the two outermost brackets A 16 and the shorter vertical members of frame B 32. The soil container structure securement unit (FIG. 1A) is connected to the front and side structures of the truck or trailer bed in the same manner to prevent the load from shifting toward the rear of the truck or trailer bed during transport.

(Not shown) If three units of nursery stock are loaded into the soil containment structure securement unit (FIG. 70), additional units of nursery stock may be loaded into the spaces between the units of nursery stock installed in the device and in the spaces between the sidewall of the truck or trailer bed and the units of nursery stock installed in the device.

(Not shown) Additional tools, materials, equipment, and nursery stock with dimensions that allow it to be loaded beneath the plant tops of the nursery stock loaded in the device may be loaded into the remaining space in the truck or trailer bed.

(Not shown) The entire load is enclosed with a commercially-available tarpaulin to protect the plant tops from wind. Ropes or straps used to attach the tarpaulin may be secured to any available portion of either the soil containment structure securement unit (FIG. 1A) or the plant top securement unit (FIG. 1B).

### DESCRIPTION

### First Alternative Embodiment—FIGS. 1A, 1B, 7, 8

The first alternative embodiment includes two or more soil containment structure securement units (FIG. 1A) as described in the first embodiment.

### OPERATION AND METHOD

### First Alternative Embodiment

This first alternative embodiment is applicable in cases where the number of nursery stock units intended to be loaded into the truck or trailer bed exceeds the number of nursery stock units that can be loaded into a single soil containment structure securement unit (FIG. 1A) as described in the first embodiment. In such cases, the first soil containment structure securement unit (FIG. 1A) is positioned on the truck or trailer bed to provide remaining space in the truck or trailer bed for one or more additional soil containment structure securement units, depending on the number of nursery stock units intended for the load.

The first three units of nursery stock are loaded into the rear-most soil containment structure securement unit (FIG. 1A) in the same manner as described in the first embodiment (FIG. 7). A second soil containment structure securement unit (FIG. 1A) is then placed on the truck or trailer bed immediately adjacent to and in front of the first (rear-most) soil containment structure securement unit (FIG. 1A), and the next three units of nursery stock are loaded in the same manner (FIG. 7). The plant tops of the nursery stock loaded in the second soil containment structure securement unit (FIG. 1A) rest on the soil containment structures and plant tops of the three units of nursery stock loaded into the first (rear-most) soil containment structure securement unit (FIG. 1A).

If required, a third and subsequent soil containment structure securement unit/s (FIG. 1A) is/are each placed and loaded with up to three additional units of nursery stock in the same manner.

The last-placed soil containment structure securement unit will thereby be positioned at the front-most position in the truck or trailer bed, and additional units of nursery stock may be loaded into the spaces between the units of nursery stock installed in the device and in the spaces between the sidewall of the truck or trailer bed and the outermost units of nursery stock installed in the device, as described in the first embodiment. This process can be repeated until the load reaches the maximum weight or space capacity of the truck or trailer bed.

The plant tops of the rear-most row of nursery stock loaded in the first soil containment structure securement unit are secured by a plant top securement unit (FIG. 1B) (FIG. 8), a rear gate, or some other method to bear the weight of the plant tops extending rearward beyond the rear-most soil containment structure securement unit (FIG. 1A).

### DESCRIPTION

### Second Alternative Embodiment—FIGS. 1A, 5

This second alternative embodiment is applicable in cases where a single unit of nursery stock is transported in a truck or trailer bed. In such cases, the soil containment structure securement unit is identical to that described in the first embodiment (FIG. 1A), with the following exceptions:
Two brackets A 16
One sling 28
The length of frame A 22 is only as long as necessary to secure a single unit of nursery stock between two brackets A 16

### OPERATION AND METHOD

### Second Alternative Embodiment

The configuration described in this second alternative embodiment provides the user with additional flexibility compared to the configuration described in the first embodiment by allowing the user to load and transport individual units of nursery stock without limiting the distribution of nursery stock in the truck or trailer bed to the configuration of the device described in the first embodiment. Each unit of nursery stock can be loaded and transported independently. Processes for assembly, installation, and loading the device described in this second alternative embodiment are the same as the processes described in the first embodiment, but limited to a single unit of nursery stock per soil container structure securement unit (FIG. 5).

### CONCLUSION, RAMIFICATIONS, AND SCOPE

Accordingly the reader will see that, according to one embodiment of the invention, I have disclosed a device and method for securing nursery stock during transport with the following advantages:
Minimizes the effects of forces that would displace soil during transport of nursery stock;
Minimizes the effects of forces that would cause the root/soil system and the plant top to move independently of each other during transport of nursery stock;
Minimizes the effects of forces that would cause damage to the plant top structure during transport of nursery stock;
Provides for nursery stock to be loaded and transported at an angle that allows the plant tops to pass safely under overhead impediments on the route of transport, or to fit within the cargo enclosure;
Provides for nursery stock to be loaded and transported at an angle that provides space beneath the plant tops for additional units of nursery stock;
Aligns and maintains the angle of the soil containment structure and the plant top during transport of nursery stock;
Supports the soil containment structure in a manner that conforms to and retains its shape during transport of nursery stock;
Provides and maintains the chocking function during transport of nursery stock to prevent the soil containment structure from rolling laterally; and
Provides for assembly and loading of the securement device onto the truck or trailer bed, effective securement of nursery stock with the device, and disassembly and unloading of the device from the truck or trailer bed to be done by one person quickly, without specialized skills, and without specialized tools in order to minimize labor costs and allow the truck or trailer bed to be utilized for other purposes.

This disclosure secures nursery stock during transport in a manner that limits damage to nursery stock that occurs when other devices and methods are used to secure nursery stock. When nursery stock is damaged during transport, the nursery and landscape industry incurs direct costs, such as reduced marketability and higher replacement costs, and indirect costs, such as reduced customer satisfaction from plant death and non-fatal, aesthetic damage. Consumers of landscape services, including residential property owners, commercial property owners, institutions, and government, incur property damage and replacement costs when the long-term effects of damages to nursery stock caused during transport become evident in the landscape. The economic, aesthetic, and emotional values of plants in the landscape are harmed when plants decline and die. As the nursery and landscape industry becomes aware of the advantages of the device and method disclosed herein, the device and method will become widely used as a “tool of the trade” for anyone who handles nursery stock.

While the above description contains many specificities, these should not be construed as limitations on the scope of any embodiment, but as exemplifications of various embodiments thereof. Many other ramifications and variations are possible within the teachings of the various embodiments. For example, a nursery or landscape firm may only deal in nursery stock in a limited number of types and sizes of soil containment structures, such that the adjustability presented in the stated embodiments of this disclosure is not an operational or financial advantage. In such cases, the company may determine that the most cost-effective way to secure nursery stock during transport is to permanently attach (weld) brackets to a frame at particular points along the frame and replace the flexible material slings with a rigid material curved to conform to a particular size and style of soil containment structure.

Thus the scope should be determined by the appended claims and their legal equivalents, and not by the examples given.

I claim:

1. A device for securing nursery stock during transport, comprising:
a. a soil containment structure securement unit comprising a plurality of rigid vertical brackets moveable along a rigid horizontal frame, and
b. each pair of said rigid vertical brackets connected by a flexible material suspended between each pair of said brackets, and
c. said soil containment structure securement unit assembled, placed on a truck or trailer bed, disassembled, and removed from the truck or trailer bed without tools or special skills.

2. A device for securing nursery stock during transport, comprising:
a. a soil containment structure securement unit comprising a plurality of rigid vertical brackets moveable along a rigid horizontal frame, and
b. each pair of said rigid vertical brackets connected by a flexible material suspended between each pair of said brackets, and
c. a plant top securement unit comprising a means to support one or more horizontal rigid bars to secure plant tops, and
d. said soil containment structure securement unit and said plant top securement unit assembled, placed on a truck or trailer bed, disassembled, and removed from the truck or trailer bed without tools or special skills.

3. A method for securing nursery stock during transport, comprising:
a. placing a device in a truck or trailer bed cargo area, and
b. placing nursery stock in said device, and
c. said device adjusting to the shape and size of a soil containment structure placed therein, and
d. said device adjusting to the height of plant tops supported thereby, and
e. holding said nursery stock at an angle allowing plant tops to pass beneath overhead obstructions, and
f. preventing said nursery stock from rolling laterally, and
g. positioning said nursery stock in a manner by which said soil containment structure and plant top do not move independently of each other, and
h. protecting said roots, soil, and plant tops from damage, and
i. minimizing labor costs for assembling, installing, disassembling, and un-installing a means for securing said nursery stock, and
j. optimizing the commercial value of nursery stock and related tools, materials, and equipment in a single truck or trailer bed, and
k. eliminating the need for other materials, devices, items, and methods used as means to secure nursery stock prior to this disclosure.
